(19) United States
(12) Patent Application Publication
(10) Pub. No.: US 2010/0318898 A1
(43) Pub. Date: Dec. 16, 2010

(54) RENDERING DEFINITIONS

(75) Inventors: Robert Thomas Owen Rees, Newport (GB); Al-Fathiatul Habibah Abdul Rahman, Bristol (GB); John William Lumley, Bristol (GB)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/483,036

(22) Filed: Jun. 11, 2009

(51) Int. Cl. G06F 17/00

(52) U.S. Cl. 715/236

(57) ABSTRACT

A method for rendering documents includes rendering a document using a rendering definition indicated within electronic data representing the document.

### BACKGROUND

Electronic documents are typically stored as digital data including parameters which determine what will be displayed and how when the document is used. This digital data is stored in a format which that various systems to read that data and render it to be displayed or printed.

Some rendering processing systems have a library of definitions that allow for alternate renditions of the documents being rendered. The rendering of an electronic document is typically optimized based on the output media and the rendition differs according to that intended output. For example, a document which is to be displayed on a monitor is rendered differently than a document to be printed onto paper. The different types of renditions may range from a simple rendering involving scaling to a more complex rendering involving document specific methods.

In order to make use of different renditions, the rendering processing system needs to know which renderings of an electronic document are available and applicable. The rendering processing system also needs to know how to apply different renderings to different types of electronic documents and even specific instances of a document.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustrative chart depicting examples of how a digital document may be rendered for different output media, according to one embodiment of principles described herein.

FIG. 2 is an illustrative chart depicting examples of how a digital document may be rendered based on user preferences, according to one embodiment of principles described herein.

FIG. 3 is an illustrative chart depicting an exemplary electronic document going through a rendering process, according to one embodiment of principles described herein.

FIG. 4 is an illustrative diagram depicting exemplary rendering definitions to be embedded in an electronic document, according to one embodiment of principles described herein.

FIG. 5 is an illustrative diagram depicting an exemplary scenario in which embedded rendering definitions could be used, according to one embodiment of principles described herein.

FIG. 6 is an illustrative diagram depicting an exemplary scenario in which embedded rendering definitions could be used, according to one embodiment of principles described herein.

FIG. 7 is an illustrative flow chart depicting the process of creation and use of an electronic document with embedded rendering definitions, according to one embodiment of principles described herein.

Throughout the drawings, identical reference numbers designate similar, but not necessarily identical, elements.

### DETAILED DESCRIPTION

As mentioned above, electronic documents can be rendered differently depending on factors such as user preference or output media. An example of user preference rendering would be a file browser. With a file browser, users are able to choose the types of views in which they wish the files and folders to appear. Different renditions or views may include large icons, small icons, or no icons next to the file and folder names.

Many word processing and publishing tools allow a file to be placed in different types of output formats such as a PDF (Portable Document Format) file to be read by Adobe Acrobat Reader. These outputs, however, do not allow any choice as to how the document is rendered regarding layout, appearance, and other presentational aspects.

Some web-pages are designed to be rendered with different style sheets. However, the style is very limited with little if any variation allowed. Web-pages are also designed to be rendered in a format readable by smaller devices such as cell-phones and PDA's (Personal Data Assistant). These renderings are very generic and do not take into account the nature of the web page being rendered and as a result, typically exhibit poor performance and limited functionality.

The principles described in the present specification relate to a method for embedding alternate rendering definitions within an electronic document itself. These rendering definitions can be optimized for document type, intended output media, and user preferences. The rendering definitions may also be specific to a particular instance of a document. The rendering definitions can be designed in such a way as to allow a document processing system to use a generic method for rendering an electronic document without being burdened with the details of the different renderings themselves. This will provide flexibility and adaptability to the rendering process.

These techniques may be used for documents that are typically produced by a word processor or publishing system. These rendering definitions are computer-readable instructions that may be implemented either as a standalone software application installed on a user's machine or provided as a web service. In some embodiments, XML (Extensible Markup Language) may be used to create the structured text content. This innovation may be implemented with its own software toolkit or be embedded in already existing toolkits.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in some embodiments” or similar phrases in various places in the specification are not necessarily all referring to the same embodiment.

As used herein and in the appended claims, an electronic document embodying principles described in the present specification will be referred to as an electronic document or just a document with embedded rendering definitions. As defined herein, a document with embedded rendering definitions may be either a document actually containing any number of rendering definitions with the document file itself or a document that contains any number of links, e.g., addresses or pointers, to accessible locations where various shared rendering definitions may be obtained.

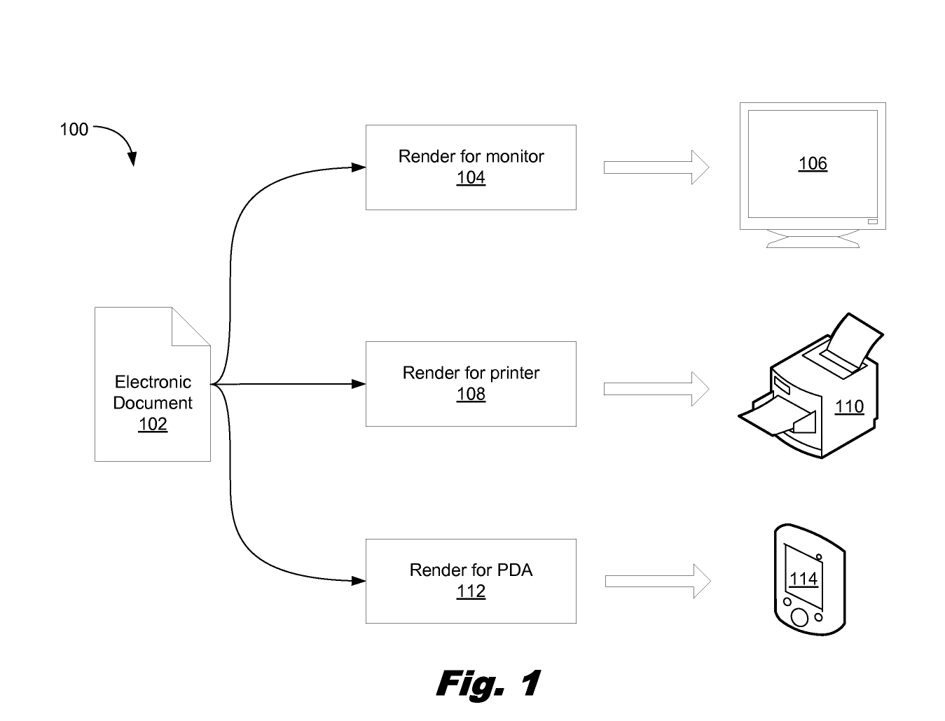

FIG. 1 is an illustrative chart (100) depicting examples of how an electronic document (102) may be rendered (104, 108, 112) for different output media (106, 110, 114). As mentioned above, electronic documents are stored in such a way so that digital data models an image. The image must be constructed from that data into a form distinguishable by a human user. This process is referred to as rendering. A rendition is a presentation of a visual image that is, for example, either printed or shown on a display device, that has been constructed from a digital model, i.e., a set of digital data. Consequently, an electronic document is any digitally stored file such as a text file, image file, or any other type of file that can be read by a compatible or associated piece of software and presented for viewing by a user.

As indicated above, the electronic document data is rendered differently depending on how the image is to be displayed, i.e., the output medium selected. For example, in order for an electronic document (102) to be rendered for display on a monitor or other display device (106), a rendering process (104) for that monitor must occur. Depending on the monitor, the electronic document (102) can be rendered in many different ways so as to be compatible with any monitor on which the document is being displayed. This is because different monitors have different sizes, aspect ratios and resolutions. In some cases, simple scaling may be all that is necessary for optimized viewing. In other cases, text reflows and re-ordering of presentational elements may be appropriate.

Likewise with a printer (110), a specific rendering process (108) must occur based on various printing variables. Such variables may include the mechanism of the printer (110), type of ink, and type of substrate on which the electronic document (102) will be printed.

Additionally, many electronic documents (102) can be rendered (112) to be viewed on a mobile device (114) such as a PDA or a cell-phone. In this case, the electronic document (102) often needs to be scaled down. Instead of presenting all of the information at once, the mobile device (114) may break the content into smaller elements with links between them. A different layout for the electronic document may also be necessary depending on the mobile device (114).

There are many more types of output media than the ones discussed herein in connection with FIG. 1. The principles described in detail below are not limited to only the alternate rendering definitions for the type of output media shown in this figure, but may be applied to prepare a document for rendering on any type of output medium given the particular parameters of that medium.

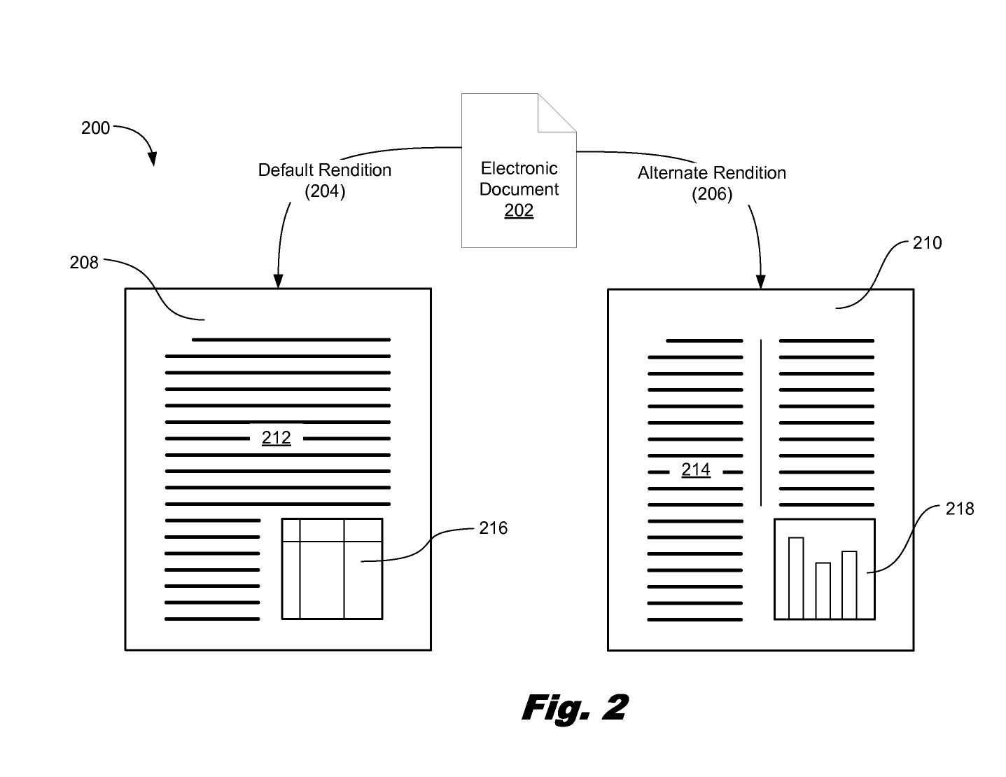

FIG. 2 is an illustrative chart (200) depicting an example of how an electronic document (202) may be rendered in two different ways regarding layout. Depending on its nature, an electronic document (202) can be rendered many different ways as to the layout of the document's content. In some instances, an electronic document may have a default rendering definition that the rendering process will use unless otherwise instructed. It may also be the case that there is no default rendering definition. The rendering process may then have some method of selecting a rendering definition from the set of definitions associated with or embodied within the document. The graphical layout of the alternate rendering definitions embedded inside the electronic document (202) may be determined by the type of document, user preferences, and output media.

Electronic documents may contain text, graphics or a combination of both. The exact layout of an electronic document (202) can thus take many forms. For example, the default rendition (204) may dictate that an electronic document be rendered as shown in the exemplary document (208) on the left side of FIG. 2. The text (212) within this document is laid out in a single column. A graphical display of information (216) in tabular form is shown at the bottom right side of the document (208).

An alternative rendition (206) of the document, i.e., the same underlying data, is shown on the right side of FIG. 2. This alternative rendition (206) may be produced in response to user preferences as described herein. In this example, represented by document (210), the text is displayed in two columns as opposed to the single column layout shown in the default rendition (204). The graphical display of information (218) is shown in a bar graph form instead of the tabular form.

In some embodiments, a user may be able to design a desired layout given specific preferences and add additional rendering definitions to the document. There may be other options and settings that different users may prefer such as alternate font types or sizes. There may be many different presentational aspects which may be defined in an alternate rendering definition (206) embedded within an electronic document (202).

In some embodiments, to avoid modifying an existing document when applying a new rendering definition, a ‘wrapper’ document containing a new rendering definition may be used. The ‘wrapper’ document may then import content from the existing document and apply the new rendering definition to that content.

The different renditions shown in this figure illustrate only two different content and layout renditions. The principles and techniques described herein are not limited to the layout options described above. Any conceivable layout with any range of alternatives may be defined in different rendering definitions associated with a document. For example, there may be many different types of documents including, but not limited to, spreadsheets and images, and of which can be rendered in many different ways based on user preference or output media.

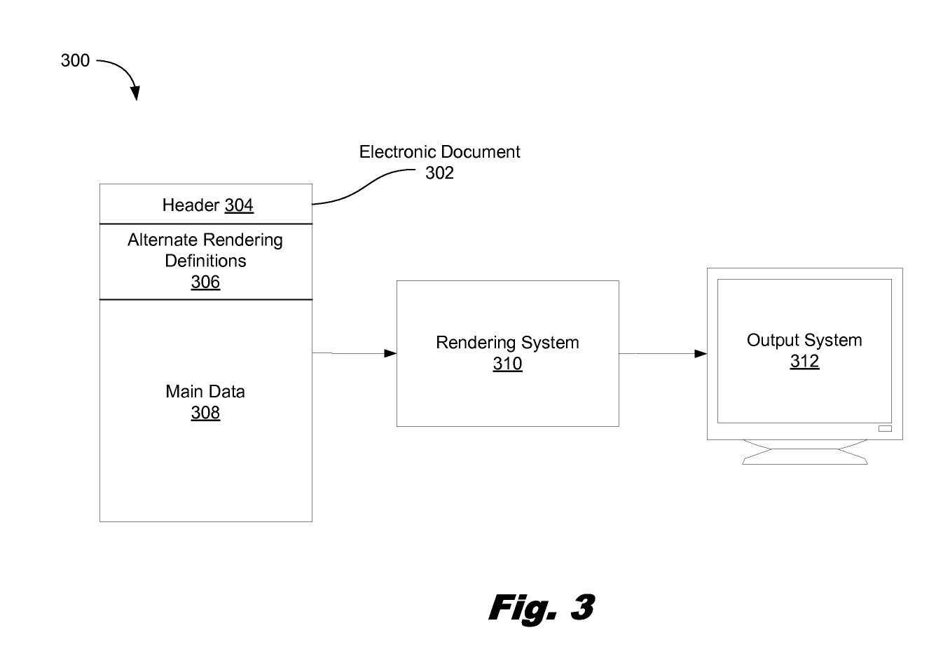

FIG. 3 is an illustrative chart (300) depicting an exemplary electronic document (302) with embedded rendering definitions (306) that is undergoing a rendering process (310). In a typical rendering process, any alternate rendering definitions that may be available are programmed as part of the rendering processing system. Consequently, there is typically only a one, or perhaps a very limited number of rendering definitions available for all types of documents. Some of the rendering processing is done by the operating system and other parts may be done by the software associated with a specific document type.

A rendering definition may be described as a transform. When the specific transform is applied to the digital data model of an image and the result is then displayed, the image is viewed in a manner dictated by that specific transform. Some rendering definitions may call for multiple transforms to construct the final representation to be output for viewing.

To avoid being limited to the rendering definition(s) available in a static rendering system, according to the principles described herein, any number of relevant alternate rendering definitions (306) may be embedded within an electronic document (302) itself.

A typical electronic document (302) is stored in a digital file that contains a file header (304) and the main body of document data (308). The main body of data constitutes the model for the image of the document. The embedded alternate rendering definitions (306) can be associated with the document in any matter. The rendering definitions contain an array of transforms that are relevant to the specific document. The rendering system (310) will then need only a generic way of applying the rendering definitions to the electronic document (302) rather than contain different rendering definitions. Consequently, the rendering system (310) may be embodied as a processor that is configured or programmed for selecting a particular rendering definition from among a number of rendering definitions embedded in or indicted by electronic data of an electronic document, and rendering the electronic document using the selected rendering definition.

This will allow for greater flexibility as the generic rendering process (310) will be able to render an electronic document (302) in a greater variety of ways. The alternate rendering definitions embedded into the electronic document (302) may also include any transforms necessary to display the document on a variety of output media.

There may be many programming methods to embed alternate rendering definitions within an electronic document. In some embodiments, eXtensible Markup Language (XML) could be used to represent the content and alternate rendering definitions (306). XML is a widely used language with various available development tool that can be used by many different systems.

Output representations can be in XML or can be generated by a standard process from an XML representation to a different type of representation. An example would be from SVG (Scalable Vector Graphics), an XML-based language for graphical data to PDF. When selecting between alternate renderings (306), the output representation would start with an XML to XML transformation. Renderings, no matter the complexity, can be done by Extensible Stylesheet Language Transformations (XSLT), an XML-based language designed specifically for performing transformations either from XML-to-XML or from XML into a format that is human-readable.

The rendering processing system (310) will then be able to use standard XML processing techniques to produce the output representation and display it on an output system (312). The rendering processing system (310) will be able to pick an alternate rendering definition (306) out of the embedded electronic document (302) and apply the necessary transforms to render the document appropriately. The exact rendering definition selected for use may depend on a number of factors including, but not limited to, document type, document instance, user preference, and intended output medium (312).

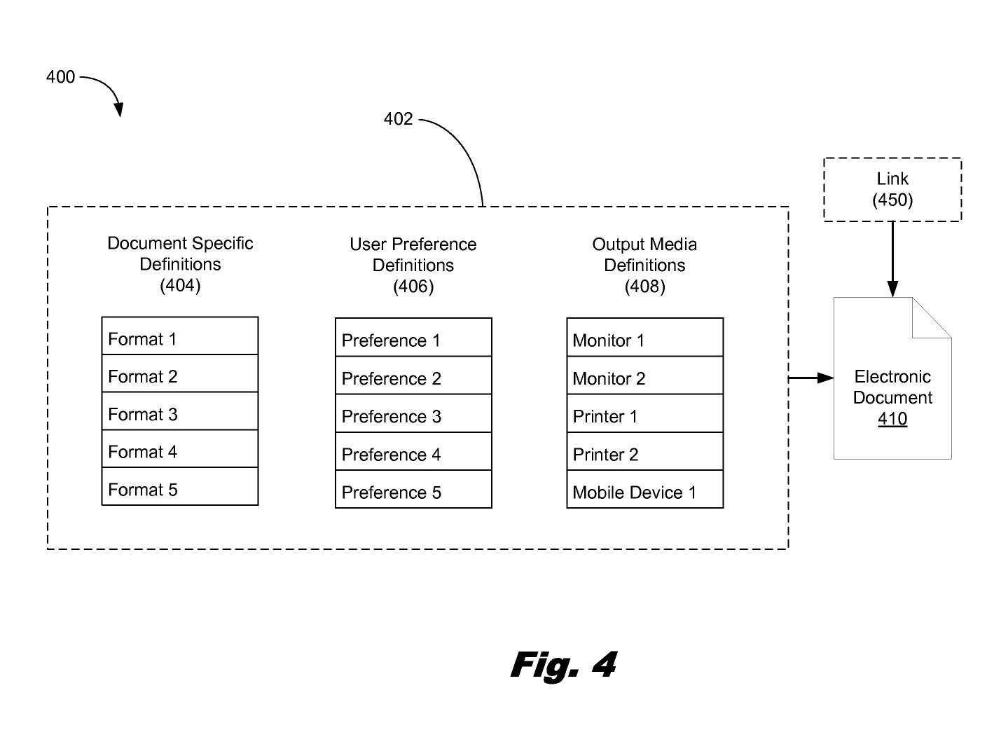

FIG. 4 is an illustrative diagram (400) depicting exemplary rendering definitions (402) to be embedded in an electronic document (410). Under the principles described herein, there are many ways to embed alternate rendering definitions into an electronic document (410) which will be described below.

An document with embedded rendering definitions can have any number of rendering definitions (402) which are relevant to the specific document type. For example, a text document containing graphs may have alternate renditions defining different layouts or graph types for displaying the underlying data. An image file may have alternate rendering definitions based on different coloring schemes.

In some embodiments, the embedded definitions could include a set for document specific renditions (404), another set for user defined renditions (406) and yet another set for output media rendering definitions. There may be any number of different renderings for different purposes. Definitions for all these different renderings can be embedded into each electronic document.

For example, if a user opens a document with embedded rendering definitions, the user's computer can render that document based on a preferred alternate rendering definition according to settings on the user's local machine. The rendering process would then work out the details of the rendition according to what output media will be used. Software on the user's machine can perform the rendering using a generic rendering method that employs the definitions embedded within the document itself.

As indicated, there are many different methods of embedding rendering definitions (402) into an electronic document (410). In some embodiments, there could be an electronic document template with the alternate rendering definitions (402) relevant to the document type already embedded. In this case, word processing software or publishing tool software would create documents from that template with many possible rendering definitions already embedded. The rendering process performed on any machine will then be able to produce an output representation based on definitions already embedded within the document.

In some embodiments, alternate rendering definitions (402) could be embedded into an already existing electronic document. If a document has been created without an existing template containing embedded rendering definitions, it may be possible to embed alternate rendering definitions (402) at a later time.

In some embodiments, the alternate rendering definitions (402) may be dynamically linked (405) with the electronic document (410). Computer systems often store thousands or even millions of electronic documents. Many of these documents are of similar type and, as a result, will contain similar rendering definitions (402). To conserve storage space, the rendering definitions (402) may be dynamically linked so that duplicate copies of rendering definitions (402) are minimized. It will be readily apparent to those skilled in the relevant art that the use of dynamic linking will allow each such document to reference a file or template containing relevant alternate rendering definitions (402).

Some systems allow for multiple templates to be combined forming a document. In such a system, alternate rendering definitions (402) may be drawn from several different templates. This provides the rendering processing system a convenient way to select an appropriate set of alternative renderings without going into the details of how each rendering is defined.

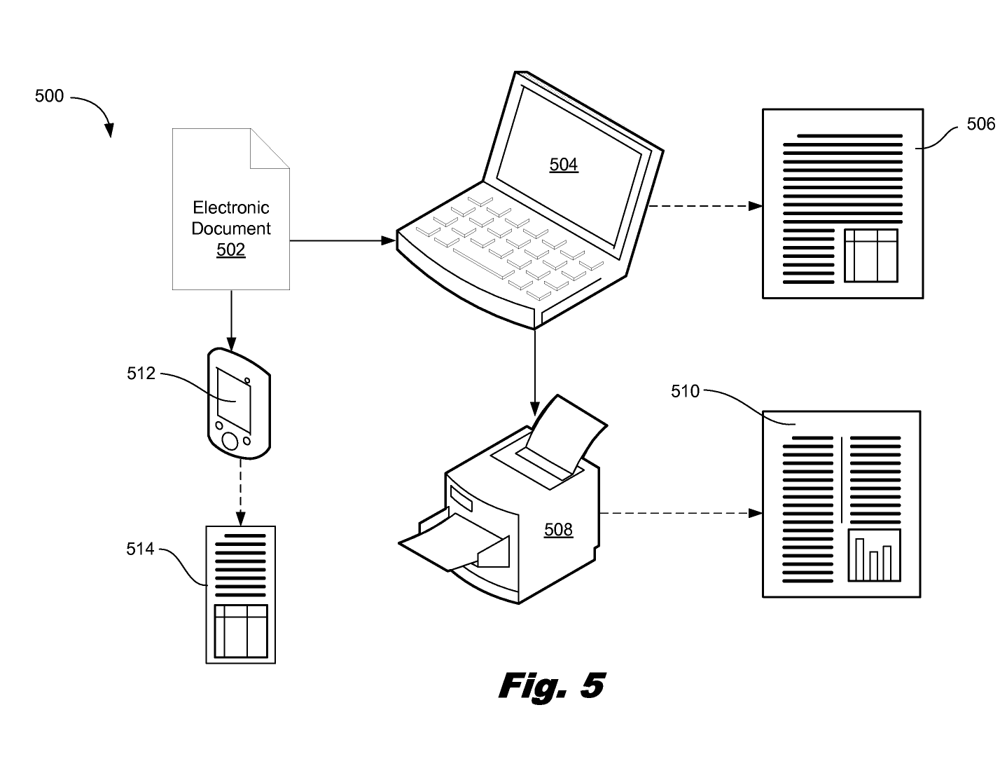

FIG. 5 is an illustrative diagram (500) depicting an exemplary scenario in which embedded rendering definitions could be used. Through use of a document with embedded rendering definitions, a user is able to take an electronic document (502) and view it on a selected output device (504).

In the illustrated example, the document, when viewed on the display device of the users' computer (504), is rendered according to the user's preferences for the document as rendered for a display device (506). In the illustrated example, these preferences include a single column of text and a tabular graph as described in FIG. 2 and shown again here in FIG. 5.

When sending the document to a printer (508), the user may prefer a different rendering layout and the settings on the computer (504) can be set to render and then print the document in a different layout (510) than the layout (506) that was viewed on the display device of the computer (504).

The user may also be able to access that same document on a mobile device (512), in which case the document will be rendered differently to be compatible with the small screen associated with typical mobile devices. The layout (514) of the document may be narrower and provide for easy scrolling to best optimize the output on the mobile device (512). Scaling and text reflow may be applied as well.

As indicated above, in some embodiments, the settings on a device or output medium may determine which rendering definition to use. There may be a default rendering definition or a rendering definition selected by the user.

This example is just one of many illustrating how a document with embedded rendering definitions may be used. Actual implementation of a document with embedded rendering definitions may have many forms of which the above example is merely one.

The computer (504) may also be programmed to both produce the document and to embed various rendering definitions in the document. For example, the computer (504) may allow the user to access an endless variety of rendering definitions and to then embed any number of such definitions in an electronic document or embed a link, e.g., an address or pointer, to desired rendering definitions in the electronic document.

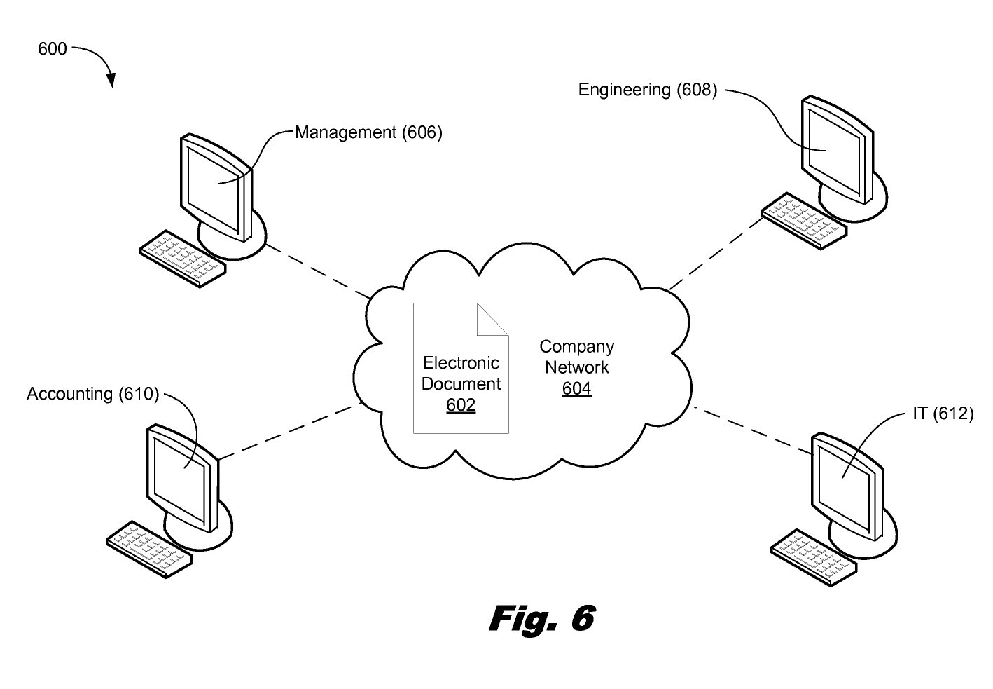

FIG. 6 is an illustrative diagram (600) depicting an exemplary scenario in which embedded rendering definitions could be used. In some embodiments, a document (602) with embedded rendering definitions could be stored somewhere on a company's network (604). The document (602) could contain alternate rendering definitions for various departmental personnel. For example, a document could contain company policy but have certain sections which are relevant to only specific departments. There could be information in the document for management (606) only. Likewise, their may be information specific to the engineering (608), accounting (610), and IT (Information Technology) (612) departments.

When a user from a specific department views the main document (602), that user will see only the relevant information based on their role in the company. The user's role in the company may be determined by, for example, the user's online identification or login credentials. A rendering definition for the document is then implemented that corresponds to the user's role in the company. Consequently, when the document is rendered for the user, the rendition is specific to or in accordance with the user's role in the company. For example, there may be certain sections of text in the document that only the engineers will see, or their may be certain sections of text only the accountants will see. The machines used by the individual personnel can have the rendering processing system be set to render the document (602) not only based on what content is relevant for them, but also their individual preferences whatever they may be.

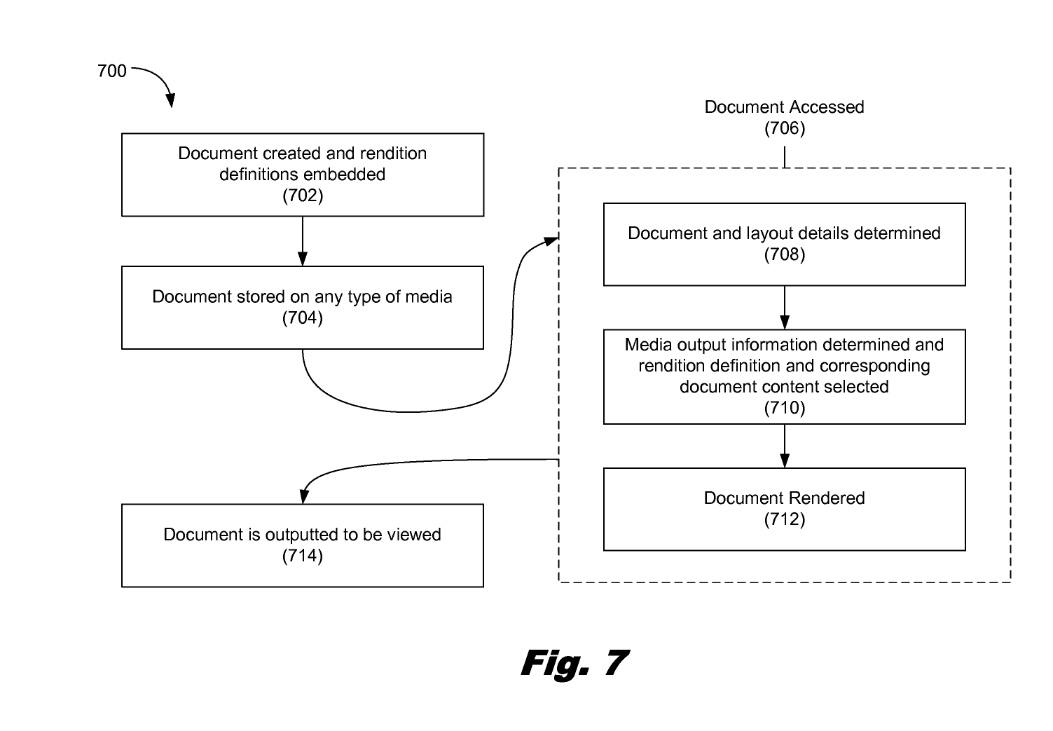

FIG. 7 is an illustrative flow chart depicting the process of creation and use of an electronic document with embedded alternate rendering definitions. Those of skill in the art will appreciate that the various steps illustrated are only illustrative and may be added to, omitted or rearranged in any order as best suits a particular application.

First, an electronic document is created and alternative rendering definitions are embedded within the document (702). This may be done on any properly configured computer, such as computer (504) as described above.

The document can either be created as a template with all the relevant definitions embedded, or an existing document can have the rendering definitions embedded at a later time. The document is then stored on any type of media (704) including, but not limited to, a hard drive, server, Flash drive, diskette, etc. The document may be available over the Internet or other network to multiple users. In other cases, the document may be stored on a local machine and available to only a few users.

When the document is accessed (706) for viewing, the document type and layout details are determined (708) based on embedded rendering definitions. The settings on the machine rendering the embedded electronic document may determine which rendition to use. Next, the media output details based on the embedded rendering definitions are determined (710). The electronic document is then ready to be rendered (712). After the document has been rendered to the final presentation, it may then be viewed through whatever output media was selected (714).

In sum, an electronic document may be associated with alternate rendering definitions. The alternate rendering definitions may either be embedded with the document, or dynamically linked in a way that allows the electronic document to reference the location of relevant alternate rendering definitions. This way, the rendering process needs only a generic way to read the embedded definitions to offer an alternate rendition as opposed to requiring a large library of definitions. The alternate renditions which are embedded in the electronic document may depend on the document type and content. The alternate renditions may offer various layouts based on document type, document instance, user preferences, user roles, and output media.

There are many advantages offered by the principles described in the present specification. By embedding alternate rendering definitions within a document, the resources of the underlying document processing system are not taken up with a large collection of rendering models. The document rendering processing system can apply whatever definitions are embedded in the document, even if they are new definitions. Because document systems are progressing at a rapid pace, new rendering methods and such are being developed. The generic document rendering processing system will be able to construct these new and sometimes complex rendering definitions for presentation using the embedded definitions. This will allow for flexibility and adaptability to new requirements and rendering methods used by modern document processing systems.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for rendering documents, the method comprising rendering a document using a rendering definition indicated within electronic data representing said document.

2. The method of claim 1, further comprising embedding at least one rendering definition in said electronic document.

3. The method of claim 1, further comprising inserting a link in said electronic document to at least one rendering definition.

4. The method of claim 1, in which the rendering definition comprises a transform.

5. The method of claim 1, further comprising:
selecting one rendering definition from among a number of rendering definitions embedded within said electronic data representing said document; and
rendering said document using that selected rendering definition.

6. The method of claim 5, further comprising selecting different content from among said electronic data depending on which of said rendering definitions is selected.

7. The method of claim 5, in which each rendering definition defines at least one of an alternate layout, coloring, or style for said document.

8. The method of claim 5, further comprising selecting said rendering definition from among said number of rendering definitions based on an intended output medium.

9. The method of claim 5, further comprising selecting said rendering definition from among said number of rendering definitions based on indicated user preferences.

10. The method of claim 5, further comprising selecting said rendering definition from among said number of rendering definitions based on a default rendering definition.

11. A system for generating electronic documents with embedded rendering definitions, the system comprising a computer configured for selectively embedding at least one rendering definition or a link to at least one rendering definition in data of an electronic document.

12. The system of claim 11, in which said computer comprises access to a number of rendering definitions, each rendering definition providing a different rendering of said electronic document.

13. A system for rendering electronic documents with embedded rendering definitions, the system comprising a processor configured for selecting a particular rendering definition from among a number of rendering definitions embedded in or indicted by electronic data of an electronic document, and rendering said electronic document using the selected rendering definition.

14. The system of claim 13, in which said processor is further configured to select different content from among said data of said electronic document depending on which of said rendering definitions is selected.

15. The system of claim 13, in which said processor is further configured to select a rendering definition from among said number of rendering definitions based on an intended output medium.
